(19) United States
(12) Patent Application Publication
(10) Pub. No.: US 2021/0380081 A1
(43) Pub. Date: Dec. 9, 2021

(54) SYSTEM AND METHOD FOR CONTROLLING DRIVING OF VEHICLE

(71) Applicant: Hyundai Mobis Co., Ltd., Seoul (KR)

(72) Inventor: Ge O PARK, Seoul (KR)

(73) Assignee: Hyundai Mobis Co., Ltd., Seoul (KR)

(21) Appl. No.: 17/330,646

(22) Filed: May 26, 2021

(30) Foreign Application Priority Data
Jun. 4, 2020 (KR) 10-2020-0067940

(51) Int. Cl. B60T 7/12

(52) U.S. Cl. CPC B60T 7/12; B60T 2201/081; B60T 2210/32; B60T 2210/24; B60T 2210/20; B60T 2201/16

(57) ABSTRACT

A system for controlling driving of a vehicle, includes one or more processors configured to collect information about another vehicle identified in a traveling direction of a host vehicle, check whether a road in the traveling direction of the host vehicle is a straight road or a curved road, and control, in response to the check, the host vehicle to travel in a direction in which the host vehicle avoids the other vehicle when the host vehicle enters a curved section of the road and the other vehicle is detected in the traveling direction of the host vehicle, and perform braking of the host vehicle such that a traveling speed of the host vehicle is reduced.

### CROSS-REFERENCE TO RELATED APPLICATION

This application claims the benefit of Korean Patent Application No. 10-2020-0067940, filed on Jun. 4, 2020 in the Korean Intellectual Property Office, the disclosure of which is incorporated herein by reference.

### BACKGROUND OF THE INVENTION

### 1. Field of the Invention

The present invention relates to a system and method for controlling driving of a vehicle to ensure safety during driving on a curved road.

### 2. Description of the Related Art

Vehicles frequently travel on curved roads as well as straight roads. During driving on a curved road, risk of collision with an oncoming vehicle increases because the view of a curved section is not secured in front of a vehicle.

That is, the recognition ability of a driver deteriorates in a situation in which the driver drives a vehicle on a curved road because the view of a curved section is not secured, and thus the driver cannot deal with the situation. Particularly, risk of collision further increases during driving on an inclined curved road.

On such a curved road, a message is conveyed through a road sign in order to prevent risk of collision. However, even if a driver recognizes the risk through the road sign, it is difficult for the driver to cope with a sudden oncoming vehicle on a curved road.

Accordingly, there is need for a method for rapidly determining presence or absence of an object in a vehicle traveling direction during traveling on a curved road and rapidly responding to a determination result to avoid collision of a vehicle.

It will be understood that the above matters described in the related art are merely for promotion of understanding of the background of the invention and should not be recognized as prior art well-known to those skilled in the art.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a system for controlling driving of a vehicle, includes one or more processors configured to collect information about another vehicle identified in a traveling direction of a host vehicle, check whether a road in the traveling direction of the host vehicle is a straight road or a curved road, and control, in response to the check, the host vehicle to travel in a direction in which the host vehicle avoids the other vehicle when the host vehicle enters a curved section of the road and the other vehicle is detected in the traveling direction of the host vehicle, and perform braking of the host vehicle such that a traveling speed of the host vehicle is reduced.

The system may further include a memory configured to store instructions. The one or more processors may be further configured to execute the instructions to configure the one or more processors to collect information about the other vehicle identified in the traveling direction of the host vehicle, check whether the road in the traveling direction of the host vehicle is the straight road or the curved road; and control, in response to the check, the host vehicle to travel in the direction in which the host vehicle avoids the other vehicle when the host vehicle enters the curved section of the road and the other vehicle is detected in the traveling direction of the host vehicle, and perform the braking of the host vehicle such that the traveling speed of the host vehicle is reduced.

The one or more processors may include an object detection unit configured to collect information about the other vehicle identified in the traveling direction of the host vehicle, a road detection unit configured to check whether the road in the traveling direction of the host vehicle is the straight road or the curved road, and a driving control unit configured to control, in response to the check, the host vehicle to travel in the direction in which the host vehicle avoids the other vehicle when the host vehicle enters the curved section of the road and the other vehicle is detected in the traveling direction of the host vehicle, and perform the braking of the host vehicle such that the traveling speed of the host vehicle is reduced.

The driving control unit may be further configured to control the host vehicle to travel in a direction opposite to a direction in which the other vehicle travels toward the host vehicle when the other vehicle is detected in the curved section.

The object detection unit may be further configured to identify obstacles around the host vehicle, and when an obstacle is present in the direction in which the host vehicle avoids the other vehicle, the driving control unit may be further configured to cause the host vehicle to be separated by a predetermined safe distance or longer from the obstacle.

The road detection unit may be further configured to identify lanes around the host vehicle, and the driving control unit may be further configured to cause the host vehicle to not cross a centerline of the road when avoiding the other vehicle.

The system may further include a correction unit configured to store braking power and braking timing depending on a distance between the host vehicle and the other vehicle and a relative speed of the other vehicle in advance, and correct the braking power and the braking timing depending on the distance between the host vehicle and the other vehicle and the relative speed of the other vehicle. The driving control unit may be further configured to brake the host vehicle with the braking power at the braking timing input through the correction unit.

The correction unit may be further configured to upwardly correct the braking power and the braking timing when the distance between the host vehicle and the other vehicle is equal to or less than a reference distance.

The correction unit may be further configured to upwardly correct the braking power and the braking timing when the relative speed of the other vehicle is equal to or higher than a reference speed.

The road detection unit may be further configured to check whether the road is an uphill road or a downhill road, and the correction unit may be further configured to downwardly correct the braking power and the braking timing when the host vehicle travels on the uphill road, and upwardly correct the braking power and the braking timing when the host vehicle travels on the downhill road.

The road detection unit may be further configured to check whether the road is a paved road or an unpaved road, and the correction unit may be further configured to upwardly correct the braking power and the braking timing when the host vehicle travels on the unpaved road.

The road detection unit may be further configured to check whether the road is in a slippery condition, and the correction unit may be further configured to upwardly correct the braking power and the braking timing when the road is in the slippery condition.

The one or more processors may be engine control units (ECUs).

In another general aspect, a method for controlling driving of a vehicle, includes an object detection operation of collecting information about another vehicle identified in a traveling direction of a host vehicle, a road detection operation of checking whether a road in the traveling direction of the host vehicle is a straight road or a curved road, and a driving control operation of controlling, in response to the road detection operation, the host vehicle to travel in a direction in which the host vehicle avoids the other vehicle when the host vehicle enters a curved section of the road and the other vehicle is detected in the traveling direction of the host vehicle, and performing braking of the host vehicle such that a traveling speed of the host vehicle is reduced.

The host vehicle may be controlled to travel in a direction opposite to a direction in which the other vehicle travels toward the host vehicle when the other vehicle is detected in the curved section in the driving control operation.

Obstacles around the host vehicle may be further identified in the object detection operation, and when an obstacle is present in the direction in which the host vehicle avoids the other vehicle, the host vehicle may be caused to be separated by a predetermined safe distance or longer from the obstacle in the driving control operation.

Lanes around the host vehicle may be identified in the road detection operation, and the host vehicle may be caused not to cross a centerline of the road when avoiding the other vehicle in the driving control operation.

The method may further include a correction operation of storing braking power and braking timing depending on a distance between the host vehicle and the other vehicle and a relative speed of the other vehicle in advance, and correcting the braking power and the braking timing depending on the distance between the host vehicle and the other vehicle and the relative speed of the other vehicle. The host vehicle may be braked with the braking power at the braking timing input through the correction unit in the driving control operation.

The braking power and the braking timing may be upwardly corrected when the distance between the host vehicle and the other vehicle is equal to or less than a reference distance in the correction operation.

The braking power and the braking timing may be upwardly corrected when the relative speed of the other vehicle is equal to or higher than a reference speed in the correction operation.

Whether the road is an uphill road or a downhill road may be further checked in the road detection operation, and the braking power and the braking timing may be downwardly corrected when the host vehicle travels on the uphill road, and upwardly corrected when the host vehicle travels on the downhill road in the correction operation.

Whether the road is a paved road or an unpaved road may be further checked in the road detection operation, and the braking power and the braking timing may be upwardly corrected when the host vehicle travels on the unpaved road in the correction operation.

Whether the road is in a slippery condition may be further checked in the road detection operation, and the braking power and the braking timing may be upwardly corrected when the road is in the slippery condition in the correction operation.

Other features and aspects will be apparent from the following detailed description, the drawings, and the claims.

### BRIEF DESCRIPTION OF THE DRAWINGS

FIG. 1 is a configuration diagram of a system for controlling driving of a vehicle according to the present invention.

FIG. 2 is a diagram showing avoidance traveling according to the system for controlling driving of a vehicle illustrated in FIG. 1.

FIG. 3 is a diagram for describing the system for controlling driving of a vehicle illustrated in FIG. 1.

FIG. 4 is a flowchart of a method for controlling driving of a vehicle according to the present invention.

### DETAILED DESCRIPTION OF THE PREFERRED EMBODIMENTS

Hereinafter, a system and method for controlling driving of a vehicle according to preferred embodiments of the present invention will be described with reference to the accompanying drawings.

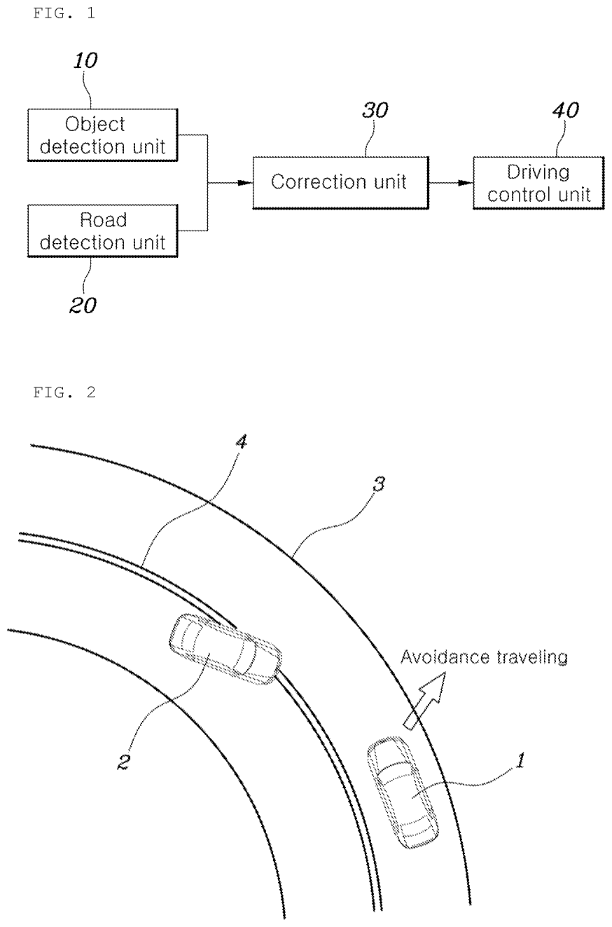

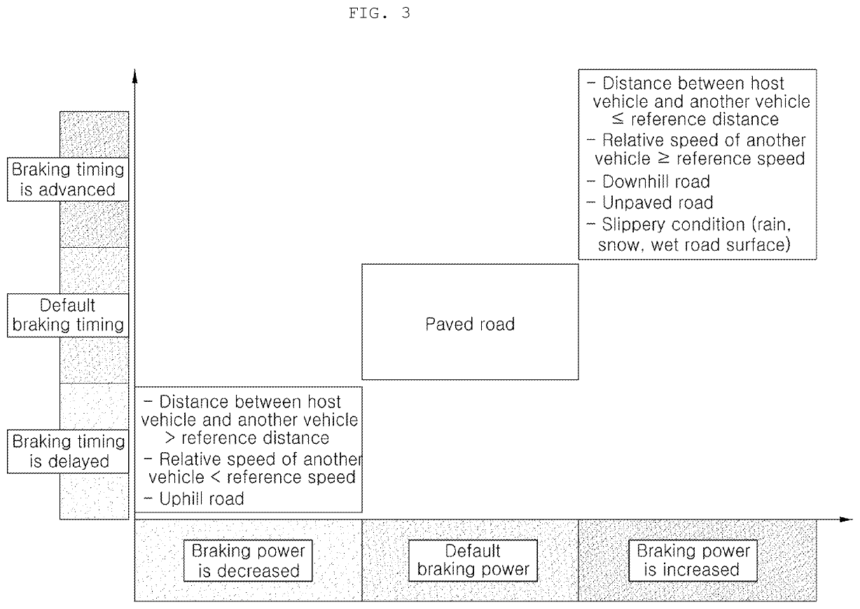

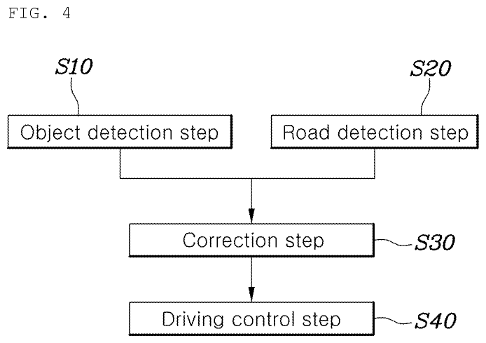

FIG. 1 is a configuration diagram of a system for controlling driving of a vehicle according to the present invention, FIG. 2 is a diagram showing avoidance traveling according to the system for controlling driving of a vehicle illustrated in FIG. 1, FIG. 3 is a diagram for describing the system for controlling driving of a vehicle illustrated in FIG. 1, and FIG. 4 is a flowchart of a method for controlling driving of a vehicle according to the present invention.

The present invention may be applied to a vehicle driven by a driver and may also be applied to an autonomous vehicle. That is, the present invention allows a driver to escape from a situation in which risk of collision may occur, which cannot be recognized by the driver, and driving may be performed not only by the driver but also according to control of an ECU.

As illustrated in FIG. 1, the system for controlling driving of a vehicle according to the present invention includes an object detection unit 10 that collects information about another vehicle 2 identified in a traveling direction of a host vehicle 1, a road detection unit 20 that checks whether a road in the traveling direction of the host vehicle 1 is a straight road or a curved road, and a driving control unit 40 that controls the host vehicle 1 to travel in a direction in which the host vehicle 1 avoids the other vehicle 2 when the host vehicle 1 enters a curved section and the other vehicle 2 is detected in the traveling direction of the host vehicle 1, and performs braking such that a traveling speed of the host vehicle 1 is reduced.

Here, the object detection unit 10 may collect information about the other vehicle 2 around the host vehicle from various sensors. The sensors may be a LiDAR, a camera, a radar, and an ultrasonic sensor and they may acquire information regarding the shape, size, speed, distance, and the like of the other vehicle 2 and recognize various obstacles 3.

The road detection unit 20 may be configured as the same sensors of the object detection unit 10, check road states, and additionally receive weather information through a navigation system and acquire various types of road information about straight roads, curved roads, uphill roads, and downhill roads.

Information about the other vehicle 2 and roads input through the object detection unit 10 and the road detection unit 20 in this manner is provided to the driving control unit 40, and the driving control unit 40 controls the vehicle on the basis of the input information. Particularly, the driving control unit 40 controls the host vehicle 1 to travel in a direction in which the host vehicle 1 avoids the other vehicle 2 such that the host vehicle 1 avoids collision with the other vehicle 2 traveling in the opposite direction when the road detection unit 20 detects the host vehicle 1 entering a curved section and the object detection unit 10 detects the other vehicle 2 in the traveling direction of the host vehicle 1. In addition, the driving control unit performs braking of the host vehicle 1 such that a traveling speed of the host vehicle 1 is reduced to allow the host vehicle 1 to easily avoid collision with the other vehicle 2. Furthermore, even if the host vehicle 1 cannot perfectly avoid the other vehicle 2, impact is reduced according to braking of the host vehicle 1.

In this manner, the present invention improves driving safety during driving to provide driving reliability to passengers.

The present invention will be described in detail. As illustrated in FIG. 2, the driving control unit 40 may control the host vehicle 1 to travel in a direction opposite to a direction in which the other vehicle 2 travels toward the host vehicle 1 upon detection of the other vehicle 2 on a curved road. The driving control unit 40 controls traveling of the host vehicle 1 and, when the other vehicle 2 approaches the host vehicle 1, controls the host vehicle 1 to travel to avoid the other vehicle 2. Here, the driving control unit 40 may cause the host vehicle 1 to travel in a direction opposite to a direction in which the other vehicle approaches on the basis of information about the other vehicle 2 around the host vehicle 1 and other objects detected through the object detection unit 10 such that the host vehicle 1 can avoid the oncoming vehicle 2 to prevent collision with the other vehicle 2.

The object detection unit 10 may identify an obstacle 3 around the host vehicle 1, and the driving control unit 40 may cause the host vehicle 1 to be separated from the obstacle 3 by a predetermined safe distance or longer when the obstacle 3 is present in a direction in which the host vehicle 1 avoids the other vehicle 2.

That is, various obstacles such as a guardrail 3 may be located on a road in addition to vehicles. Accordingly, the driving control unit 40 receives information about the obstacle 3 through the object detection unit 10 and controls a vehicle such that the vehicle travels in an area where the obstacle 3 is not present or travels while maintaining the safe distance or longer from the obstacle 3. Here, the safe distance may be set according to the shape and size of the host vehicle 1 and set to a distance at which the host vehicle 1 does not collide with the obstacle 3 to avoid collision.

By confirming the obstacle 3 around the host vehicle and avoiding collision with the other vehicle 2 in consideration of the obstacle 3 in this manner, driving stability is further secured.

Further, the road detection unit 20 may identify lanes around the host vehicle 1, and the driving control unit 40 may cause the host vehicle 2 not to cross a centerline 4 when avoiding the other vehicle 2.

A road is divided into lanes that define the same traveling direction and lanes that define an opposite traveling direction. Particularly, the centerline 4 divides lanes in opposite traveling directions, and accident risk is very high when a vehicle crosses the centerline 4.

Accordingly, when the driving control unit 40 controls the host vehicle 1 to travel in a direction in which the host vehicle 1 avoids the other vehicle 2, the driving control unit 40 may control the host vehicle 1 to travel in a direction in which the other vehicle 2 is not present and not to cross the centerline 4 such that the host vehicle 1 avoids the oncoming vehicle.

Meanwhile, the present invention performs braking of the host vehicle 1 when the host vehicle 1 avoids the other vehicle 2 in a curved section to further ensure safety. Here, the present invention provides a correction unit 30 that corrects braking power and braking timing in order to efficiently perform braking of the host vehicle 1.

The correction unit 30 stores braking power and braking timing depending on a distance between the host vehicle 1 and the other vehicle 2 and a relative speed of the other vehicle 2 in advance, and the driving control unit 40 corrects braking power and braking timing depending on a distance between the host vehicle 1 and the other vehicle 2 and a relative speed of the other vehicle 2. Then, the driving control unit 40 performs braking of the host vehicle 1 using braking power and braking timing input through the correction unit 30 such that the host vehicle 1 stably avoids the other vehicle 2.

That is, when the distance between the host vehicle 1 and the other vehicle 2 is short or the relative speed of the other vehicle 2 is high, risk of collision with the other vehicle 2 is high. In this case, braking pressures is increased to perform strong braking, and braking timing is advanced to rapidly perform braking. On the other hand, when the distance between the host vehicle 1 and the other vehicle 2 is long or the relative speed of the other vehicle 2 is low, risk of collision with the other vehicle 2 is low and thus smooth braking is performed.

Specifically, the correction unit 30 upwardly corrects braking power and braking timing when the distance between the host vehicle 1 and the other vehicle 2 is equal to or less than a reference distance. Here, the reference distance is a prestored value, which may be set depending on the size and weight of the host vehicle 1.

That is, when the distance between the host vehicle 1 and the other vehicle 2 is equal to or less than the reference distance, risk of collision between the host vehicle 1 and the other vehicle 2 is high, and thus the correction unit 30 upwardly corrects braking power and braking timing such that avoidance of collision between the host vehicle 1 and the other vehicle 2 is stably performed through strong braking. Here, upwardly correcting braking power is to increase braking pressure, and braking powers capable of ensuring safety according to distances between the host vehicle 1 and the other vehicle 2 may be stored in advance. Furthermore, upwardly correcting braking timing is to advance the braking timing, and braking timings capable of ensuring safety according to distances between the host vehicle 1 and the other vehicle 2 may be stored in advance.

When the correction unit 30 corrects the braking power and the braking timing, the driving control unit 40 causes the host vehicle 1 to travel in a direction in which the host vehicle 1 avoids the other vehicle 2 and brakes the host vehicle 1 with the braking power at the braking timing corrected depending on the distance between the host vehicle 1 and the other vehicle 2 upon detection of the other vehicle 2 in a state in which the host vehicles has entered a curved section. Accordingly, a time for which the host vehicle 1 can avoid the other vehicle 2 is secured according to rapid and strong braking. Therefore, the host vehicle 1 can easily avoid the other vehicle 2 and, even if the host vehicle 1 cannot avoid the other vehicle 2, the traveling speed is reduced according to rapid braking to decrease impact.

The correction unit 30 may upwardly correct braking power and braking timing when the relative speed of the other vehicle is equal to or higher than a reference speed.

That is, the object detection unit 10 may collect speed information about the other vehicle 2, and the correction unit 30 may determine a degree of risk by receiving the speed information about the other vehicle 2 and comparing the speed information with the prestored reference speed. That is, when the speed of the other vehicle 2 approaching the host vehicle 1 is high, the host vehicle 1 may slowly respond to the other vehicle 1 or impact may increase in case of collision, and thus braking power and braking timing are corrected additionally depending on the speed of the other vehicle 2.

Specifically, when the relative speed of the other vehicle 2 is equal to or higher than the reference speed, the correction unit 30 upwardly corrects braking power and braking timing. Here, the reference speed is a speed at which the host vehicle 1 can respond to and avoid the other vehicle 2 approaching the host vehicle 1 and is derived and stored in advance. That is, when the relative speed of the other vehicle 2 is equal to or higher than the reference speed, risk of collision between the host vehicle 1 and the other vehicle 2 increases, and thus the correction unit 30 upwardly corrects braking power and braking timing to rapidly brake the host vehicle 1. Accordingly, the host vehicle 1 can respond to the other vehicle 2 detected in a curved section and safely avoid the other vehicle 2. Even if the host vehicle 1 cannot avoid the other vehicle 2, impact is reduced according to rapid braking.

The road detection unit 20 may further check whether the road is an uphill road or a downhill road, and the correction unit 30 may downwardly correct braking power and braking timing when the host vehicle 1 travels on the uphill road and upwardly correct the braking power and braking timing when the host vehicle 1 travels on the downhill road.

That is, when the host vehicle 1 travels on an uphill road, the host vehicle 1 can be rapidly braked even with low braking power. Accordingly, the correction unit 30 downwardly corrects braking power and braking timing when the host vehicle 1 travels on an uphill road such that excessive braking is prevented from making a passenger feel uncomfortable in a situation in which the host vehicle 1 can avoid the other vehicle 2 when the other vehicle 2 is detected in a curved section. On the other hand, when the host vehicle 1 travels on a downhill road, the host vehicle may be slowly braked even with high braking power. Accordingly, the correction unit 30 upwardly corrects braking power and braking timing when the host vehicle 1 travels on a downhill road. Accordingly, when the other vehicle 2 is detected in a curved section, the host vehicle 1 is stably braked according to rapid and strong braking and thus can safely avoid the other vehicle 2.

Further, the road detection unit 20 may further check whether the road is a paved road or an unpaved road, and the correction unit 30 may upwardly correct braking power and braking timing when the host vehicle 1 travels on the unpaved road. Normal braking can be performed in the case of a paved road, whereas normal braking may not be performed due to an uneven road surface in the case of an unpaved road. Accordingly, when the host vehicle 1 enters an unpaved road, the correction unit 30 upwardly corrects braking power and braking timing to perform stable braking. By rapidly braking the host vehicle 1 with high braking power in this manner, the host vehicle 1 can avoid collision with the other vehicle 2 even on an unpaved road.

Further, the road detection unit 20 may further check whether the road in the traveling direction of the host vehicle 1 is in a slippery condition, and the correction unit 30 may upwardly correct braking power and braking timing when the road is in a slippery condition. Here, the road detection unit 20 may identify a slippery road surface through weather information, a rain sensor, and the like.

When a road state is identified as a slippery condition through the road detection unit 20 in this manner, the correction unit 30 may upwardly correct braking power and braking timing such that stable braking is performed even when the host vehicles 1 skids during braking. Accordingly, the host vehicle 1 is rapidly braked with high braking power even in a slippery road surface condition and thus can stably avoid collision with the other vehicle 2.

In the above-described correction of braking power and braking timing through the correction unit 30, braking power and braking timing are added according to each situation and upwardly or downwardly corrected, and thus stable and precise braking control can be performed in accordance with each situation.

A method for controlling driving of a vehicle according to the present invention includes an object detection step S10 of collecting information about the other vehicle 2 identified in a traveling direction of the host vehicle 1, a road detection step S20 of checking whether a road in the traveling direction of the host vehicle 1 is a straight road or a curved road, and a driving control step S40 of controlling the host vehicle 1 to travel in a direction in which the host vehicle 1 avoids the other vehicle 2 when the host vehicle 1 enters a curved section and the other vehicle 2 is detected in the traveling direction of the host vehicle 1, and performing braking such that a traveling speed of the host vehicle 1 is reduced.

Accordingly, the host vehicle 1 is controlled to travel in a direction in which the host vehicle 1 avoids the other vehicle 2 such that the host vehicle 1 avoids collision with the other vehicle 2 traveling in the opposite direction when the host vehicle 1 enters a curved section and the other vehicle 2 is detected in the traveling direction of the host vehicle 1. In addition, the host vehicle 1 is braked such that a traveling speed of the host vehicle 1 is reduced and thus can easily avoid collision with the other vehicle 2. Furthermore, even if the host vehicle 1 cannot perfectly avoid the other vehicle 2, impact is reduced according to braking of the host vehicle 1.

Here, in the driving control step S40, when the other vehicle 2 is detected in a curved section, the host vehicle is controlled to travel in a direction opposite to a direction in which the other vehicle 2 travels toward the host vehicle 1 such that the host vehicle 1 can avoid the other vehicle 2 traveling in the opposite direction to prevent collision with the other vehicle 2.

An obstacle 3 around the host vehicle 1 is identified in the object detection step S10, and the host vehicle 1 is caused to be separated from the obstacle 3 by a predetermined safe distance or longer when the obstacle 3 is present in a direction in which the host vehicle 1 avoids the other vehicle 2 in the driving control step S40. By identifying the object 3 around the host vehicle 1 at the time of controlling driving of the host vehicle 1 and controlling driving of the host vehicle 1 in consideration of the obstacle 3 in this manner, driving safety is ensured.

Further, lanes around the host vehicle 1 are identified in the road detection step S20, and the host vehicle 2 is caused not to cross a centerline 4 when avoiding the other vehicle 2 such that the host vehicle 1 avoids the oncoming vehicle 2 in the opposite direction in the driving control step S40.

The method for controlling driving of a vehicle further includes a correction step S30 of storing braking power and braking timing depending on a distance between the host vehicle 1 and the other vehicle 2 and a relative speed of the other vehicle 2 in advance and correcting braking power and braking timing depending on a distance between the host vehicle 1 and the other vehicle 2 and a relative speed of the other vehicle 2, and braking of the host vehicle 1 is performed using braking power and braking timing input in the correction step S30 in the driving control step S40.

Specifically, braking power and braking timing may be upwardly corrected when the distance between the host vehicle 1 and the other vehicle 2 is equal to or less than a reference distance in the correction step S30. In addition, braking power and braking timing may be upwardly corrected when the relative speed of the other vehicle 2 is equal to or higher than a reference speed in the correction step S30.

Accordingly, rapid and strong braking is performed in consideration of the distance between the host vehicle 1 and the other vehicle 2 and the relative speed of the other vehicle 2 in a high collision risk situation to secure a time for which the host vehicle 1 can avoid the other vehicle 2, and thus the host vehicle 1 can easily avoid the other vehicle 2 and, even if the host vehicle 1 cannot avoid the other vehicle 2, the traveling speed of the host vehicle 1 is reduced according to rapid braking to decrease impact.

Further, whether the road is an uphill road or a downhill road is further checked in the road detection step S20, and braking power and braking timing may be downwardly corrected when the host vehicle 1 travels on the uphill road and upwardly corrected when the host vehicle 1 travels on the downhill road in the correction step S30.

Further, whether the road is a paved road or an unpaved road is further checked in the road detection step S20, and breaking power and braking timing may be upwardly corrected when the host vehicle 1 travels on the unpaved road in the correction step S30.

Further, whether the road is in a slippery condition is further checked in the road detection step S20, and braking power and braking timing may be upwardly corrected when the road is in a slippery condition in the correction step S30.

As described above, the present invention determines the slope, pavement state, slippery condition, and the like of a road and corrects braking power and braking timing depending on a road state when the other vehicle 2 is detected on a curved road. Accordingly, the host vehicle 1 is efficiently braked and thus can safely avoid the other vehicle 2 or impact is reduced in a collision situation to improve safety.

According to the system and method for controlling driving of a vehicle configured as above, a vehicle can avoid an oncoming vehicle in an opposite direction when traveling on a curved road and thus driving safety is ensured. Furthermore, it is possible to efficiently avoid an oncoming vehicle by performing braking depending on a degree of risk of collision of a vehicle and adjusting braking power and braking timing depending on a road state to improve safety.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for controlling driving of a vehicle, comprising:
one or more processors configured to:
collect information about another vehicle identified in a traveling direction of a host vehicle;
check whether a road in the traveling direction of the host vehicle is a straight road or a curved road; and
control, in response to the check, the host vehicle to travel in a direction in which the host vehicle avoids the other vehicle when the host vehicle enters a curved section of the road and the other vehicle is detected in the traveling direction of the host vehicle, and perform braking of the host vehicle such that a traveling speed of the host vehicle is reduced.

2. The system of claim 1, further comprising a memory configured to store instructions;
wherein the one or more processors are further configured to execute the instructions to configure the one or more processors to:
collect information about the other vehicle identified in the traveling direction of the host vehicle;
check whether the road in the traveling direction of the host vehicle is the straight road or the curved road; and
control, in response to the check, the host vehicle to travel in the direction in which the host vehicle avoids the other vehicle when the host vehicle enters the curved section of the road and the other vehicle is detected in the traveling direction of the host vehicle, and perform the braking of the host vehicle such that the traveling speed of the host vehicle is reduced.

3. The system of claim 1, wherein the one or more processors comprise:
an object detection unit configured to collect information about the other vehicle identified in the traveling direction of the host vehicle;
a road detection unit configured to check whether the road in the traveling direction of the host vehicle is the straight road or the curved road; and
a driving control unit configured to control, in response to the check, the host vehicle to travel in the direction in which the host vehicle avoids the other vehicle when the host vehicle enters the curved section of the road and the other vehicle is detected in the traveling direction of the host vehicle, and perform the braking of the host vehicle such that the traveling speed of the host vehicle is reduced.

4. The system of claim 3, wherein the driving control unit is further configured to control the host vehicle to travel in a direction opposite to a direction in which the other vehicle travels toward the host vehicle when the other vehicle is detected in the curved section.

5. The system of claim 3, wherein the object detection unit is further configured to identify obstacles around the host vehicle, and when an obstacle is present in the direction in which the host vehicle avoids the other vehicle, the driving control unit is further configured to cause the host vehicle to be separated by a predetermined safe distance or longer from the obstacle.

6. The system of claim 3, wherein the road detection unit is further configured to identify lanes around the host vehicle, and the driving control unit is further configured to cause the host vehicle to not cross a centerline of the road when avoiding the other vehicle.

7. The system of claim 3, further comprising a correction unit configured to store braking power and braking timing depending on a distance between the host vehicle and the other vehicle and a relative speed of the other vehicle in advance, and correct the braking power and the braking timing depending on the distance between the host vehicle and the other vehicle and the relative speed of the other vehicle,
wherein the driving control unit is further configured to brake the host vehicle with the braking power at the braking timing input through the correction unit.

8. The system of claim 7, wherein the correction unit is further configured to upwardly correct the braking power and the braking timing when the distance between the host vehicle and the other vehicle is equal to or less than a reference distance.

9. The system of claim 7, wherein the correction unit is further configured to upwardly correct the braking power and the braking timing when the relative speed of the other vehicle is equal to or higher than a reference speed.

10. The system of claim 7, wherein the road detection unit is further configured to check whether the road is an uphill road or a downhill road, and the correction unit is further configured to downwardly correct the braking power and the braking timing when the host vehicle travels on the uphill road, and upwardly correct the braking power and the braking timing when the host vehicle travels on the downhill road.

11. The system of claim 1, wherein the one or more processors are engine control units (ECUs).

12. A method for controlling driving of a vehicle, comprising:
an object detection operation of collecting information about another vehicle identified in a traveling direction of a host vehicle;
a road detection operation of checking whether a road in the traveling direction of the host vehicle is a straight road or a curved road; and
a driving control operation of controlling, in response to the road detection operation, the host vehicle to travel in a direction in which the host vehicle avoids the other vehicle when the host vehicle enters a curved section of the road and the other vehicle is detected in the traveling direction of the host vehicle, and performing braking of the host vehicle such that a traveling speed of the host vehicle is reduced.

13. The method of claim 12, wherein the host vehicle is controlled to travel in a direction opposite to a direction in which the other vehicle travels toward the host vehicle when the other vehicle is detected in the curved section in the driving control operation.

14. The method of claim 12, wherein obstacles around the host vehicle are further identified in the object detection operation, and when an obstacle is present in the direction in which the host vehicle avoids the other vehicle, the host vehicle is caused to be separated by a predetermined safe distance or longer from the obstacle in the driving control operation.

15. The method of claim 12, wherein lanes around the host vehicle are identified in the road detection operation, and the host vehicle is caused not to cross a centerline of the road when avoiding the other vehicle in the driving control operation.

16. The method of claim 12, further comprising a correction operation of storing braking power and braking timing depending on a distance between the host vehicle and the other vehicle and a relative speed of the other vehicle in advance, and correcting the braking power and the braking timing depending on the distance between the host vehicle and the other vehicle and the relative speed of the other vehicle,
wherein the host vehicle is braked with the braking power at the braking timing input through the correction unit in the driving control operation.

17. The method of claim 16, wherein the braking power and the braking timing are upwardly corrected when the distance between the host vehicle and the other vehicle is equal to or less than a reference distance in the correction operation.

18. The method of claim 16, wherein the braking power and the braking timing are upwardly corrected when the relative speed of the other vehicle is equal to or higher than a reference speed in the correction operation.

19. The method of claim 16, wherein whether the road is an uphill road or a downhill road is further checked in the road detection operation, and the braking power and the braking timing are downwardly corrected when the host vehicle travels on the uphill road, and upwardly corrected when the host vehicle travels on the downhill road in the correction operation.

20. A non-transitory computer-readable storage medium storing instructions that, when executed by one or more processors, cause the one or more processors to perform the method of claim 12.
